(19) United States
(12) Patent Application Publication
(10) Pub. No.: US 2026/0120110 A1
(43) Pub. Date: Apr. 30, 2026

(54) CLOUD-BASED TOKENIZATION FOR VALUE TRANSFER

(71) Applicant: NCR Voyix Corporation, Atlanta, GA (US)

(72) Inventors: Gina Torcivia Bennett, Lawrenceville, GA (US); Wuchieh James Jong, Raleigh, NC (US); Kip Oliver Morgan, Atlanta, GA (US)

(21) Appl. No.: 18/933,676

(22) Filed: Oct. 31, 2024

(51) Int. Cl. G06Q 20/40; G06Q 20/20; G06Q 20/38

(52) U.S. Cl. CPC G06Q 20/407; G06Q 20/209; G06Q 20/382

(57) ABSTRACT

A cloud-based system manages tokens for tipping and small payments in service industries. Customers purchase tokens at point-of-sale (POS) terminals and/or Self-Service Terminals (SSTs), which are registered with unique identifiers in an enterprise or cloud-based database. These tokens can be physical objects with stamped or printed denominations. Customers distribute tokens to service workers, who redeem them for cash or goods. The system includes features like expiration dates, loyalty account linking, and token recycling. The system addresses the decline of cash tipping by providing a secure, flexible alternative that maintains the practice of rewarding good service. The system aims to solve problems such as unfair tip distribution, safety concerns with carrying cash, and the inconvenience of cashless transactions in tipping scenarios.

### BACKGROUND

In recent years, the shift towards cashless transactions has created significant challenges for service workers who traditionally rely on cash tips as a substantial portion of their income. This trend has affected a wide range of industries, including hospitality, transportation, personal services, and entertainment. As consumers increasingly prefer digital payment methods, many service workers find themselves at a disadvantage, potentially experiencing a decline in their overall earnings. The problem extends beyond just the financial impact on workers; it also affects businesses that depend on motivated staff to provide high-quality customer service. Furthermore, this shift has created inconveniences for consumers who wish to show appreciation for good service but find themselves without the means to do so in a cash-free environment.

### BRIEF DESCRIPTION OF THE DRAWINGS

FIG. 1 is a diagram of a system for issuing, redeeming, and managing tip tokens, according to an example embodiment.

FIG. 2 is a flow diagram of a method for issuing, redeeming, and managing tip tokens, according to an example embodiment.

FIG. 3 is a flow diagram of another method for issuing, redeeming, and managing tip tokens, according to an example embodiment.

### DETAILED DESCRIPTION

Embodiments herein seek to address several key problems in the modern service economy. For example, many service workers are not receiving the tips they deserve because customers no longer carry cash; some managers take cuts of their employee's cash tips, leading to unfair distribution; tip pooling can be unfair to high-earning employees; many point-of-sale (POS) systems require tips to be given before the service is performed, which may not accurately reflect the quality of service received; people are reluctant to carry cash for safety reasons, leading to a decrease in tipping; carrying cash is inconvenient for many customers; and cash can be easily lost, creating a risk for both customers and service workers.

To address these issues, the embodiments of the technology disclosed herein provide a novel solution that leverages unique tokens that can be exchanged at POS terminals and/or self-service terminals (SSTs) for goods, cash, or paycheck money to create a cashless tipping system. These tokens serve as a digital equivalent of cash tips, allowing customers to show appreciation for good service without the need to carry physical currency.

An embodiment relates to a method for registering and managing these unique tokens through an enterprise or cloud-based database. Customers can purchase these tokens at POS terminals or SSTs using various forms of payment, including credit cards. The tokens are then stored in the database as ‘active’ with a unique identifier, allowing the retailer to track the amount of tip tokens purchased and tip tokens redeemed.

Embodiments of the disclosed technology address safety concerns by eliminating the need for cash while still providing a means to tip service workers. In addition, flexibility is provided by allowing customers to choose the expiration period and amount for each token. To ensure fairness, only employees of the retailer may be permitted to redeem tip tokens for cash and/or goods, thereby preventing unauthorized use.

In addition to tipping, embodiments presented herein also enable the use of tokens for small payments in various service scenarios. For instance, tokens can be used to pay for services such as luggage handling, valet parking, public restroom access in some countries, or other small transactions where cash was traditionally preferred. This versatility extends the utility of the token system beyond mere tipping, providing a comprehensive solution for various small-value transaction in the service industry. By accommodating these diverse uses cases, the system offers greater flexibility to both customers and service providers, further addressing the challenges posed by the decline of cash usage in everyday transactions.

Furthermore, embodiments herein incorporate features to protect both customers and employees. Customers can register tokens with their loyalty identifier or credit card, allowing for recovery of lost or stolen tokens. Employees can take pictures of received tokens as a backup in case of loss. Embodiments also include measures to prevent fraudulent redemption of lost or stolen tokens.

By providing a secure, flexible, and convenient method for tipping, the embodiments presented herein provide a technical solution that address the aforementioned problems associated with the decline of cash usage in the service industry, while maintaining the cultural practice of tipping as a vehicle for showing appreciation for good service.

As used herein a “token” or “tip token” is a unique digitally assigned and managed identifier, which is then provided via a physical media to a purchasing customer for delivery by the customer to an employee. For example, the unique identifier can be: printed on a piece of paper; stamped or labeled on a unique object; stamped, labeled, or engraved on a non-government backed or non-monetary value coin; embedded within a passive radio frequency identification (RFID) tag and attached to an object; and/or embedded within an active RFID tag that is programmable to include a custom unique identifier and attached to an object, etc.

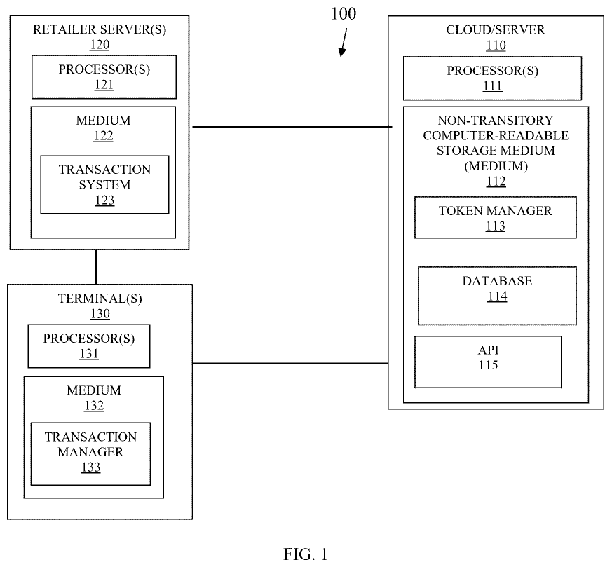

FIG. 1 is a diagram of a system 100 for issuing, redeeming, and managing tip tokens, according to an example embodiment, according to an example embodiment. Notably, the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of issuing, redeeming, and managing tip tokens, presented herein and below.

System 100 includes a cloud 110 or server, one or more retailer servers 120, and one or more terminals 130. Cloud 110 includes at least one processor 111 and a non-transitory computer-readable storage medium 112 (medium), which includes instructions for a token manager 113 and an application programming interface (API) 115. The instructions when executed by the processor 111 cause the processor 111 to perform operations discussed herein and below with respect to token manager 113 and API 115. Medium 112 also includes a database 114.

Each retailer server 120 includes at least one processor 121 and a medium 122, which includes instructions for a transaction system 123. The instructions when executed by the processor 121 cause the processor 121 to perform operations discussed herein and below with respect to transaction system 123.

Each terminal 130 includes at least one processor 131 and a medium 132, which includes instructions for a transaction manager 133. The instructions when executed by the processor 131 cause the processor 131 to perform operations discussed herein and below with respect to transaction manager 133.

Initially, retailers register with token manager 113, via a user interface, for utilizing tip tokens for their staff or employees. During registration, the retailer end user can provide specific unique identifiers that are to be associated with the retailer's tip tokens or a range of unique identifiers that are available for use. The retailer end user can also define monetary denominations associated with specific unique identifiers or sub-ranges of unique identifiers. Alternatively, the end user can request that the unique identifiers be generated and handled by the token manager 113. In this way, the unique identifiers associated with the physical medium used by the retailer for their tip tokens can be assigned by the retailer or delegated for assignment to the token manager 113.

During registration, the retailer end user may also set a default expiration date for any unique identifier whose status is changed from inactive to active. The default expiration date is a length of time that extends from a date that a unique identifier's status is set to active to a calculated expiration date. For example, if the default expiration data is 1 month and a given unique identifier is set to an active state on January 1, the expiration data for the unique identifier is calculated by token manager 113 to be February 1.

Once a given retailer has registered, has the physical medium objects to distribute tip tokens, and has defined the range or specific usable unique identifiers for the tokens, the embodiments proceed as follows. A customer of a store for a retailer purchases a tip token for use as a tip to an employee of the store. The tip token is purchased via a terminal 130.

Transaction manager 133 provides a user interface that includes an option to purchase tip tokens. User interface screens are presented to the customer for the customer to identify the monetary amount desired by the customer for each of the tip tokens that the customer desires to purchase. The customer can purchase the tip tokens at SSTs or at cashier-assisted POS terminals within the store.

The transaction manager 133 provides an intuitive and user-friendly interface for both token purchase and redemption. For customers, the interface presents a clear menu of token denominations, allowing easy selection and quantity adjustment. The interface also offers a summary view of the selected tokens before finalizing the purchase. For employees redeeming tokens, the interface provides a streamlined process where they can quickly input their employee ID and the token's unique identifier. The system 100 then displays the token's value and redemption options (cash or store credit). To enhance usability, the interface incorporates visual cues such as color-coding for different denominations and confirmation screens to prevent errors. Additionally, for RFID-based tokens, the interface guides users through the scanning process with on-screen instructions and feedback.

In an embodiment, the transaction manager 133 allows customers to purchase tokens of varying denominations in a single transaction. The user interface presents options for selecting different monetary values for each token, enabling customers to create a customized set of tip tokens tailored to their needs. For instance, a customer could purchase a combination of $1, $5, and $10 tokens in the same transaction. The system 100 handles this by registering unique identifiers for each token, regardless of denomination, and associating them with their respective monetary values in the database. This flexibility allows customers to prepare for various tipping scenarios, from small gestures to more substantial rewards for exceptional service, all within a single purchase process.

In an embodiment, the customer during purchase of tip tokens, through the user interface screens of transaction manager 133, can also link the purchase of the tip tokens to a customer loyalty account of the customer with the store. This provides the customer an ability to request a refund of tip tokens that are unused through the association of the tip tokens directly with a specific customer. This also provides the customer with an ability to seek reissued tip tokens when the customer loses their tip tokens and such tip tokens were not yet redeemed.

In an embodiment, the customer during purchase of the tip tokens, through the user interface screens of transaction manager 133, can provide a set expiration date for which the tip tokens will expire and request an option that any expired tip tokens be refundable to the customer. In an embodiment, the customer also links their store loyalty account during the initial purchase of the tip tokens. Any customer-defined expiration date can override any default expiration date set by the retailer during tip token registration. Alternatively, and in some embodiments, a customer-defined expiration date cannot exceed a retailer-defined default expiration date.

In an embodiment, transaction manager 133 interacts with transaction system 123 and/or token manager 113 to provide the unique identifiers for the tip token transactions, the monetary value of each tip token, corresponding unique identifier of each tip token, any loyalty account identifier for a customer linked loyalty account, and any customer-defined expiration date to token manager 113. Token manager 113 identifies the retailer and the store of purchase through identifiers associated with the retailer, store, and/or terminal 130 and locates a table within the database 114 associated with the store. The token manager 113 locates, within the table, records associated each unique identifier being used for the tip token transaction. Token manager 113 modifies each record to change a corresponding unique identifier's state from inactive to active, assign a corresponding monetary value, insert any customer loyalty identifier, and insert any customer-defined expiration date.

In an embodiment, the token manager 113 selects and supplies the unique identifier to associate with the token rather than the unique identifier being provided by terminal 130. This may be the case in situations where the unique identifier is being printed on receipt paper as the token.

In an embodiment, the transaction manager 133 provides the unique identifier to associate with the token. This may be the case where the token is an object other than paper such as non-monetary coins that are pre-stamped or engraved with the unique identifier, trinkets or other objects that include an RFID tag that includes the unique identifier, etc. For example, a casino might use custom-minted non-monetary coins as tokens, with different denominations represented by different colors or sizes. These coins could have the unique identifier engraved on one side and the casino's logo on the other. A $5 tip token might be a silver-colored coin, while a $10 tip token could be gold-colored. These physical tokens provide a tangible and familiar way for customers to tip, reminiscent of casino chips, while still maintaining the digital tracking benefits of the system. Similarly, a theme park could use branded trinkets with embedded RFID tags as tokens, combining the souvenir aspect with the tipping functionality.

The token manager 113 sends a confirmation back to transaction manager 113 indicating that the tip token transaction was successfully recorded by the token manager 113. The tip token purchases are then provided to the customer in a number of manners.

In an embodiment, the unique identifier is printed out by the terminal 130 on paper via a receipt printer and dispensed to the customer as the token. In an embodiment, each purchased token is printed on a separate piece of receipt paper. In an embodiment, all of the purchased tip tokens are printed on a same piece of receipt paper with spacing between each unique identifier allowing the customer to tear and separate each unique identifier from the receipt paper for individual use by the customer. In an embodiment, the terminal 130 prints the unique identifier for each purchased token on a label, the label is then applied to a surface of a trinket, non-monetary coin, or other object by the customer. The trinket, non-monetary coin, or other object is available at the terminal for the customer to obtain and place the corresponding label thereon.

In an embodiment, the terminal 130 programs an active RFID tags to the unique identifiers associated with the tip token purchase. An object with the RFID tag is then provided to the customer for use as the token. In an embodiment, the unique identifier associated a passive RFID tag was read by the transaction manager 133 during communication with the token manager 113 such that the object that includes the passive RFID tag is provided to the customer.

In an embodiment, the system 100 implements robust security measures for RFID-based tokens to prevent fraud and unauthorized use. The RFID tags used for tokens are encrypted, and each tag contains a unique, randomly generated identifier that is associated with the token's value in the secure database. When an RFID token is scanned for redemption, the system 100 performs real-time verification of the token's authenticity and status. Additionally, the RFID tags are designed to be tamper-evident, meaning any attempt to modify or duplicate the tag will render it invalid. The system 100 also employs frequency hopping and challenge-response authentication protocols to prevent unauthorized reading or cloning of the RFID tags. These security features ensure that even if a token is lost or stolen, it cannot be fraudulently redeemed, maintaining the integrity of the tipping system 100.

A customer is permitted to be refunded for a purchased token based on preconfigured rules enforced and verified by token manager 113. For example, a customer can obtain a refund of the associated monetary value associated with a tip token when the customer linked their loyalty account at the time the tip token was purchased, a retail enforced expiration date has not expired, and the tip token is still listed as active and not listed as inactive for having been redeemed. The customer can obtain the monetary refund by providing their loyalty identifier to a terminal 130. Token manager 113 locates the corresponding records and verifies that a refund is acceptable according to the rules. Token manager 113 sends back a verification to transaction manager 133 and the monetary refund is provided to the customer. In an embodiment, the customer is permitted to use the token for small payments as discussed above.

A customer that registers their loyalty account during a tip token purchase can also request new tip tokens when the originally purchased tip tokens are lost. In this case, transaction manager 133 confirms with token manager that the customer's original purchased unique identifiers are still active and non-redeemed. Once confirmation is received, transaction manager 133 interacts with token manager 113 to reissue new tip tokens for use by the customer and token manager 113 sets the original unique identifiers associated with the lost tip tokens to inactive within the database 114.

With the exception of the above-noted situations where a customer obtains reissued tokens for lost tokens or obtains a monetary refund for tokens previous purchased, just employees of the store are permitted to redeem the tokens. Customers provide the tokens to employees of the store as tips for appreciation of good service.

The employees can redeem the received tip tokens at a terminal 130 by providing their employee identification number and providing the unique identifiers for each token. Employees can take photographs of the unique identifiers associated with their tokens and use the photographs to provide the unique identifiers of each token. This makes it more convenient for the employees so that they do not have to carry around a pocketful of paper or other objects. In cases where the objects associated with the tokens are RFID tags, the employee may still need to retain the object having the RFID tag unless the employee's phone is equipped with an RFID tag reader.

During an employee redemption of a tip token, transaction manager 133 provides a user interface screen for employee redemption, which requires that the employee provide their employee identification number or log in to their employee account. Once transaction manager 133 confirms the identity of the employee and provides the unique identifiers, transaction manager 133 sends the unique identifiers to token manager 113 for verification. Assuming the unique identifiers are set to an active status in the database 114, token manager 113 returns a verification and monetary value for each unique identifier to transaction manager 113. The employee is then presented with user interface options to proceed with a transaction to purchase goods or to receive the accumulated monetary value as cash at the terminal. If the accumulated monetary value exceeds a transaction from purchasing goods, the change is dispensed as cash to the employee. If the accumulated monetary value is short of the transaction total, the employee provides a payment method to cover the difference.

In an embodiment, transaction system 123 periodically interacts with token manager 113 to obtain a listing of all expired tokens and their accumulated monetary value. The accumulated monetary value is pooled together and dispensed to the employees of the store. In an embodiment, the pooled dispensing of monetary value for expired tokens occurs once a week, twice monthly, once a month, and/or quarterly.

In an embodiment, transaction system 123 permits tokens to be purchased online via customer-operated devices. The customer can then print the tokens for use or receive them digitally. The online purchase of tokens is integrated into third-party services through interaction between the user with the third-party services and the transaction system 123 with the third-party services. This integration allows for seamless token purchases across various platforms and services. For example, a food delivery app could offer the option to purchase tip tokens along with a meal order, or a hotel booking website could include token purchases as part of the reservation process. The system 100 can also integrate with tour booking platforms, allowing customers to pre-purchase tokens for tour guides. These integrations extend the utility of the token system beyond individual retail locations, creating a more comprehensive and flexible tipping ecosystem across multiple service industries.

In an embodiment, the system 100 provides comprehensive reporting and analytics capabilities to businesses utilizing the token system. Transaction system 123 generates detailed reports on token usage, including purchase patterns, redemption rates, and employee performance metrics related to received tips. These reports can be customized based on various parameters such as time periods, departments, or individual employees. For instance, a restaurant manager can access data on which servers receive the most tokens, peak tipping times, or the average tip amount per table. This information can be used to improve service quality, adjust staffing levels, or implement targeted training programs. Additionally, the system 100 can provide insights on customer behavior, such as the correlation between token purchases and loyalty program participation. These analytics tools enable businesses to make data-driven decisions to enhance customer satisfaction and employee performance, ultimately leading to improved overall service and increased revenue.

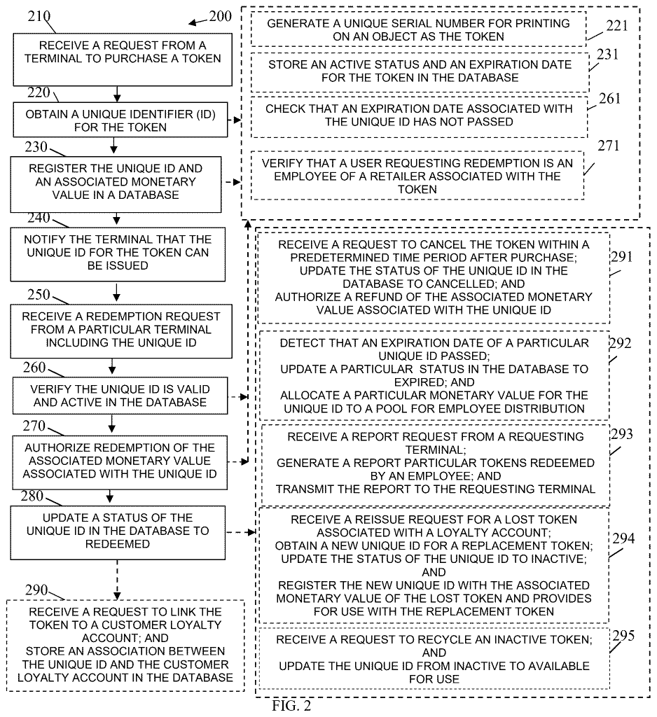

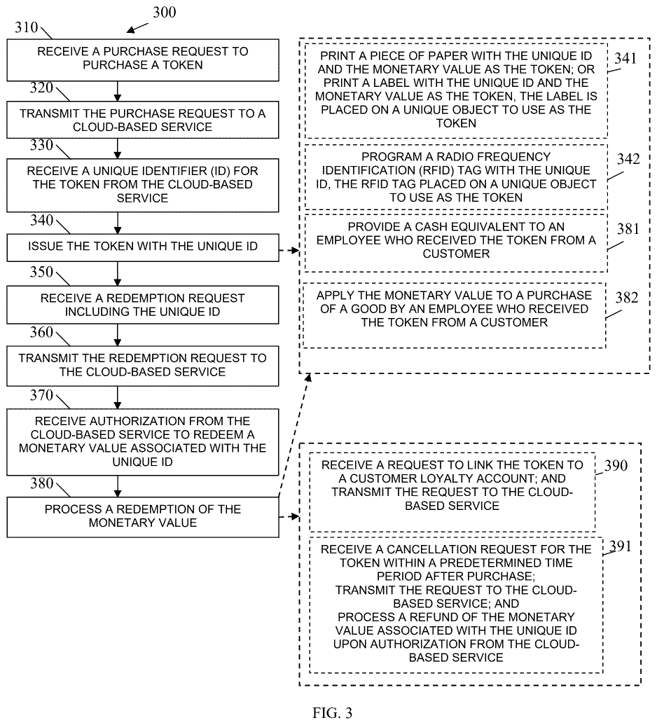

The above-referenced embodiments and other embodiments are now discussed within FIGS. 2-3. FIG. 2 is a diagram of a method 200 for issuing, redeeming, and managing tip tokens, according to an example embodiment. The software module(s) that implements the method 200 is referred to as a “cloud-based token service.” The cloud-based token service is implemented as executable instructions programmed and residing within memory and/or a non-transitory computer-readable (processor-readable) storage medium and executed by one or more processors of one or more devices. The processor(s) of the device that executes the cloud-based token service are specifically configured and programmed to process the cloud-based token service. The cloud-based token service may have access to one or more network connections during its processing. The network connections can be wired, wireless, or a combination of wired and wireless.

In an embodiment, the device that executes the cloud-based token service is cloud 110. In an embodiment, the device that execute the cloud-based token service is retailer server 120. In an embodiment, the cloud-based token service is token manager 113 and API 115.

At 210, the cloud-based token service receives a request from a terminal 130 to purchase a token. In an embodiment, the cloud-based token service is token manager 113.

At 220, the cloud-based token service obtains a unique identifier for use with the token. In an embodiment, at 221, the cloud-based token service generates a unique serial number for printing on an object as the token. In an embodiment, the cloud-based token service receives the unique identifier with the request.

At 230, the cloud-based token service registers the unique identifier and an associated monetary value in a database for the token. In an embodiment, at 231, the cloud-based token service stores an active status and an expiration date for the token in the database.

At 240, the cloud-based token service notifies the terminal 130 that the unique identifier for the token is ready for use or can be used. This is an indication that the terminal 130 can provide the token as an object with the unique identifier stamped, printed, or labeled on the object. In an embodiment, the object associated is also printed, stamped, or labeled with the monetary value associated with the token.

At 250, the cloud-based token service receives a redemption request from a particular terminal 130 that includes the unique identifier. In an embodiment, the individual redeeming the token is an employee of a store associated with the token. In an embodiment, the individual redeeming the token is a customer who original purchased the token and is seeking the monetary value associated with the token as a refund.

At 260, the cloud-based token service verifies the unique identifier is valid and active in a database 114. In an embodiment, at 261, the cloud-based token service check that an expiration date associated with the unique identifier has not passed,

At 270, the cloud-based token service authorizes redemption of the associated monetary value associated with the unique identifier. In an embodiment, at 271, the cloud-based token service verifies that a user requesting redemption is an employee of a retailer associated with the token.

At 280, the cloud-based token service, updates a status of the unique identifier in the database 114 to redeemed. In an embodiment, the cloud-based token service stamps a redeemed date and a redeemer identifier for the redeemer in field of a record associated with the unique identifier within the database 114; the cloud-based token service then changes the status for the unique identifier to inactive for reuse by the store or retailer.

In an embodiment, at 290, the cloud-based token service receives a request to link the token to a customer loyalty account. The cloud-based token service stores an association between the unique identifier and the customer loyalty account such as storing a loyalty identifier for the customer within the record of the database 114 associated with the unique identifier.

In an embodiment, at 291, the cloud-based token service receives a request to cancel the token within a predetermined time period after purchase. The cloud-based token service updates the status of the unique identifier in the database 114 to cancelled and inactive and the cloud-based token service authorizes a refund of the associated monetary value associated with the unique identifier.

In an embodiment, at 292, the cloud-based token service detects that an expiration data of a particular unique identifier has passed. The cloud-based token service updates a particular status in the database 114 to expired and inactive and the cloud-based token service allocates a particular monetary value for the particular unique identifier to a pool for employee distribution.

In an embodiment, at 293, the cloud-based token service receives a report request from a requesting terminal 130. The cloud-based token service generates a report of particular tokens redeemed by an employee and the cloud-based token service transmits the report to the requesting terminal 130.

In an embodiment, at 294, the cloud-based token service receives a reissue request for a lost token associated with a loyalty account. The cloud-based token service obtains a new unique identifier for a replacement token and updates the status of the unique identifier to inactive. The cloud-based token service registers the new unique identifier with the associated monetary value of the lost token and provides for use with the replacement token.

In an embodiment, at 295, the cloud-based token service receives a request to recycle an inactive token. The cloud-based token service updates the unique identifier from inactive to available for use. This recycling process offers several benefits to both businesses and customers. Firstly, it promotes environmental sustainability by reducing waste, as physical tokens can be reused multiple times instead of being discarded after a single use. Secondly, it provides cost-effectiveness for businesses, as they can reuse existing tokens rather than continually producing new ones. The recycling feature also allows for more efficient inventory management of physical tokens. For example, a restaurant can maintain a pool of reusable tokens, reducing the need for frequent reordering. Additionally, the recycling process can be integrated with the token expiration system, automatically making expired tokens available for reuse, further streamlining the token management process. This recycling capability enhances the overall efficiency and sustainability of the token system, making it an attractive solution for businesses looking to implement a modern, eco-friendly tipping method.

FIG. 3 is a diagram of another method 300 for issuing, redeeming, and managing tip tokens, according to an example embodiment. The software module(s) that implements the method 300 is referred to as a “transaction token manager.” The transaction token manager is implemented as executable instructions programmed and residing within memory and/or a non-transitory computer-readable (processor-readable) storage medium and executed by one or more processors of a device. The processors that execute the transaction token manager are specifically configured and programmed for processing the transaction token manager. The transaction token manager may have access to one or more network connections during its processing. The network connections can be wired, wireless, or a combination of wired and wireless.

In an embodiment, the device that executes the transaction token manager is terminal 130. In an embodiment, transaction token manager is transaction manager 133. The transaction token manager interacts with method 200 of FIG. 2. In an embodiment, the terminal 130 is an SST or a POS terminal. The transaction token manager also interacts with transaction system 123 of retailer server 120.

At 310, the transaction token manager receives a purchase request to purchase a token. At 320, the transaction token manager transmits the purchase request to a cloud-based service (e.g., method 200 and/or token manager 113).

At 330, the transaction token manager receives a unique identifier for the token from the cloud-based service. At 340, the transaction token manager issues the token with the unique identifier.

In an embodiment, at 341, the transaction token manager prints a piece of paper with the unique identifier and the monetary value as the token. Alternatively, the transaction token manager prints a label with the unique identifier and the monetary value as the token. The label is then placed on a unique object to use as the token.

In an embodiment, at 342, the transaction token manager programs an active RFID tag with the unique identifier. The RFID take is placed on or already placed on a unique object to use as the token.

At 350, the transaction token manager receives a redemption request that includes the unique identifier. At 360, the transaction token manager transmits the redemption request to the cloud-based service.

At 370, the transaction token manager receives authorization from the cloud-based service to redeem a monetary value associated with the unique identifier. At 380, the transaction token manager processes a redemption of the monetary value.

In an embodiment, at 381, the transaction token manager provides a cash equivalent to an employee who received the token from a customer. In an embodiment, at 382, the transaction token manager applies the monetary value to a purchase of a good by an employee who received the token from a customer.

In an embodiment, at 390, the transaction token manager receives a request to link the token to a customer loyalty account. The transaction token manager transmits the request along with a customer loyalty identifier to the cloud-based service.

In an embodiment, at 391, the transaction token manager receives a cancellation request for the token within a predetermined time period after purchase. The transaction token manager transmits the request to the cloud-based service to update a status of the unique identifier from active to inactive and available. The transaction token manager processes a refund of the monetary value associated with the unique identifier upon authorization from the cloud-based service.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a cloud-based service, a request from a terminal to purchase a token;
obtaining, by the cloud-based service, a unique identifier for the token;
registering, by the cloud-based service, the unique identifier and an associated monetary value in a database;
notifying, by the cloud-based service, the terminal that the unique identifier for the token can be issued;
receiving, by the cloud-based service, a redemption request from a particular terminal including the unique identifier;
verifying, by the cloud-based service, the unique identifier is valid and active in the database;
authorizing, by the cloud-based service, redemption of the associated monetary value associated with the unique identifier of the token; and
updating, by the cloud-based service, a status of the unique identifier in the database to redeemed.

2. The method of claim 1, wherein obtaining further comprises generating a unique serial number for printing on an object as the token.

3. The method of claim 1, wherein registering further comprises storing an active status and an expiration date for the token in the database.

4. The method of claim 1, wherein verifying further comprises checking that an expiration date associated with the unique identifier has not passed.

5. The method of claim 1, wherein authorizing further comprises verifying that a user requesting redemption is an employee of a retailer associated with the token.

6. The method of claim 1, further comprising:
receiving, by the cloud-based service, a request to link the token to a customer loyalty account; and
storing, by the cloud-based service, an association between the unique identifier and the customer loyalty account in the database.

7. The method of claim 1, further comprising:
receiving, by the cloud-based service, a request to cancel the token within a predetermined time period after purchase;
updating, by the cloud-based service, the status of the unique identifier in the database to cancelled; and
authorizing, by the cloud-based service, a refund of the associated monetary value associated with the unique identifier.

8. The method of claim 1, further comprising:
detecting, by the cloud-based service, that an expiration date associated with a particular unique identifier has passed;
updating, by the cloud-based service, a particular status of the particular unique identifier in the database to expired; and
allocating, by the cloud-based service, a particular monetary value associated with the particular unique identifier to a pool for distribution among employees.

9. The method of claim 1, further comprising:
receiving, by the cloud-based service, a report request from a requesting terminal;
generating, by the cloud-based service, a report of particular tokens redeemed by an employee; and
transmitting, by the cloud-based service, the report to the requesting terminal.

10. The method of claim 1, further comprising:
receiving, by the cloud-based service, a reissue request for a lost token associated with a customer loyalty account;
obtaining, by the cloud-based service, a new unique identifier for a replacement token;
updating, by the cloud-based service, the status of the unique identifier to inactive; and
registering, by the cloud-based service, the new unique identifier with the associated monetary value and providing the new unique identifier for use with of the replacement token.

11. The method of claim 1, further comprising:
receiving, by the cloud-based service, a recycling request for an inactive token; and
updating, by the cloud-based service the unique identifier from inactive to available for purchase and use.

12. A method, comprising:
receiving, by a terminal, a purchase request to purchase a token;
transmitting, by the terminal, the purchase request to a cloud-based service;
receiving, by the terminal, a unique identifier for the token from the cloud-based service;
issuing, by the terminal, the token with the unique identifier;
receiving, by the terminal, a redemption request including the unique identifier;
transmitting, by the terminal, the redemption request to the cloud-based service;
receiving, by the terminal, authorization from the cloud-based service to redeem a monetary value associated with the unique identifier; and
processing, by the terminal, a redemption of the monetary value.

13. The method of claim 12, wherein issuing further comprises:
printing a piece of paper with the unique identifier and the monetary value as the token; or
printing a label with the unique identifier and the monetary value as the token, wherein the label is placed on a unique object to use as the token.

14. The method of claim 12, wherein issuing further comprises programming a radio frequency identification (RFID) tag with the unique identifier as the token, wherein the RFID tag placed on a unique object to use as the token.

15. The method of claim 12, wherein processing further comprises providing a cash equivalent to an employee who received the token from a customer.

16. The method of claim 12, wherein processing further comprises applying the monetary value to a purchase of a good by an employee who received the token from a customer.

17. The method of claim 12, further comprising:
receiving, by the terminal, a request to link the token to a customer loyalty account; and
transmitting, by the terminal, the request to the cloud-based service.

18. The method of claim 12, further comprising:
receiving, by the terminal, a cancellation request for the token within a predetermined time period after purchase;
transmitting, by the terminal, the cancellation request to the cloud-based service; and
processing, by the terminal, a refund of the monetary value associated with the unique identifier upon authorization from the cloud-based service.

19. A system, comprising:
a cloud-based service including a processor and a memory, the memory storing instructions that, when executed by the processor, cause the cloud-based service to:
receive a purchase request from a terminal to purchase a token;
generate a unique identifier for the token;
register the unique identifier and an associated monetary value in a database;
transmit the unique identifier to the terminal for issuance of the token;
receive a redemption request from a terminal including the unique identifier;
verify the unique identifier is valid and active in the database;
authorize redemption of the associated monetary value associated with the unique identifier; and
update a status of the unique identifier in the database to redeemed; and
a terminal including a processor and a memory, the memory storing instructions that, when executed by the processor, cause the terminal to:
receive the purchase request to purchase a token;
transmit the purchase request to the cloud-based service;
receive the unique identifier for the token from the cloud-based service;
issue the token with the unique identifier;
receive a redemption request including the unique identifier;
transmit the redemption request to the cloud-based service;
receive authorization from the cloud-based service to redeem the associated monetary value associated with the unique identifier; and
process the redemption of the associated monetary value.

20. The system of claim 19, wherein the terminal is a self-service terminal or a point-of-sale terminal.
